(19) United States
(12) Patent Application Publication
(10) Pub. No.: US 2025/0221477 A1
(43) Pub. Date: Jul. 10, 2025

(54) Finger Protectors for Guitar Playing

(71) Applicant: Arthur Buswell, Lisle, IL (US)

(72) Inventor: Arthur Buswell, Lisle, IL (US)

(21) Appl. No.: 19/009,966

(22) Filed: Jan. 4, 2025

Related U.S. Application Data
(60) Provisional application No. 63/617,708, filed on Jan. 4, 2024.

(51) Int. Cl. A41D 13/08; A41D 31/18

(52) U.S. Cl. CPC A41D 13/087; A41D 31/18

(57) ABSTRACT

A finger-protector device for guitar playing includes a substantially stiff shell formed as a tube with an open base end and a substantially closed distal end with a touch hole to allow a guitar player to touch a selected guitar string with the finger. The device is sized and shaped to fit tightly over a distal portion of a finger. A circumferential-edge can be provided surrounding the touch-hole to further assist fretting of a guitar string. A cut-out extending from the substantially circular perimeter toward the distal end of the shell provides some space between fingers for finger crowding requirements for playing certain chords.

This application claims the benefit of U.S. Provisional Patent Application Ser. No. 63/617,708, filed Jan. 4, 2024.

### BACKGROUND

The fact that fretting a guitar is hard on the fingers is supported by the number of commercial products directly addressing the issue.

For reference, a typical guitar is described. FIGS. 10A and 10B show such an instrument. Item identities are assigned to the important parts of the guitar in these figures. FIG. 10A indicates the group of six guitar strings as Item GS.

The high-E-string and low-E-string indicated as Items HiE and LoE are shown in FIG. 10A. Be advised that the terms “High” and “Low” have nothing to do with direction up or direction down. The high-E-string is simply higher in musical pitch than the low-E-string. In both FIGS. 10A and 10B the saddle is represented by Item SDDL. The saddle is one anchor point for each string. In both FIGS. 10A and 10B Item F0 indicates the other anchor point for each string.

The measured distance between the two string anchor points just described is the “scale length” of the guitar. The majority of classical guitars sold measure 650 mm but high quality 640 mm instruments can be purchased or custom ordered from quality luthiers.

There is an important measurement associated with fret 0 (F0). The measurement name is F0-width (item 101: FIG. 10A). For guitars relevant to this document, F0-width is either 2 inches for traditional classical guitars or 1⅞ inches for the cross-over type.

In FIGS. 10A and 10B: fret 0 (Item F0), fret 1 (Item F1), fret 2 (Item F2) and fret 3 (Item F3) are metal strips imbedded in and protruding above the fingerboard (FB).

In both FIGS. 10A and 10C, the guitar headstock is represented by Item HS. In FIG. 10A, the guitar soundboard is represented by item SB. The vibration of the strings causes the soundboard to vibrate and produce the sound heard by the listener. In FIG. 10B the guitar neck is represented by Item GN. In FIG. 10B the angle of view is such that all six strings line up to appear as a single string.

In FIG. 10C and many of the figures, the left-hand fingers, first finger, second finger, third finger, and pinky are given item identities D1, D2, D3, D4, for “Digit 1”, “Digit 2” etc.

In FIG. 10C, a performer presses down on the high-E-string (HiE) to the headstock (HS) side of fret 1 (F1). The performer uses his left-hand first finger (D1). Arm pad (AP) protects the performer's forearm. In guitar parlance the performer has “fretted” a note with his left first finger.

Notice in FIG. 10C that the player has positioned his finger to the headstock (HS) side of fret 1 (F1). The high-E-string (HiE) is pushed against fret 1 (F1) to create a standing wave vibration node. Being constructed of metal, fret 1 (F1) does not sap energy from the vibrating high-E-string.

In FIG. 10C, the player uses a pick (PK) in his right hand to strike the high-E-string (HiE) to sound a note.

In FIG. 10C, the high-E-string (HiE) is fretted and struck as just described. This results in a standing wave vibration envelope with a node at fret 1 (F1) and a node at the Saddle (SDDL).

FIG. 10C depicts a right-handed instrument where the left-hand frets strings and the right hand, with fingernails or pick (PK), strikes the strings. The principles of this document are equally valid for a left-handed instrument where the roles of the hands are reversed. Only right-handed play is described in this document. Further, this document is only concerned with the left hand, the “fretting” hand.

In FIG. 10B it is apparent that the strings rise gradually higher above the frets from fret 0 (F0) to fret 3 (F3) and beyond. Only fret 0 through fret 3 are addressed individually in this document but fret numbering continues up to nineteen for a standard classical guitar. Playing notes at the higher frets is referred to as “playing up the neck” in guitar parlance.

Playing up the neck requires more muscularity of the forearm and places more stress on finger joints because of the greater distance a string must be pressed to touch the frets below. Many players using bare fingers never range up the neck because of that added difficulty.

To bring a string against the desired fret requires a force that crushes the soft fingertip. FIG. 16 shows the fingertip creasing 160 that occurs from the act of fretting. The muscles, tendons, and joints behind those fingertips are stressed as well.

Many people have hands sturdy enough to play music that they have mastered. The problem Is that their hands are not sturdy enough to survive practice. Practice requires repeating the same musical phrases over and over. These aspiring bare-fingered players do not have the endurance to become proficient at the music they could eventually play. Guitar practice with bare fingers is “repetitive stress” that can lead to poor outcomes for finger muscles, tendons and joints.

The following prior art patent designs are intended for guitar play:

U.S. Pat. Nos. 5,390,371; 6,393,616; 1,748,053; 3,927,595; 5,515,762; 4,694,508; 5,981,856; 9,892,653B1; U.S. Pat. Nos. 10,403,245; 8,269,084; 3,638,525; 3,854,368; 4,817,488; 5,981,856; 9,255,815; 6,160,212; 7,476,792; 5,323,677.

The prior art example of FIG. 17 has built up silicone rubber pads for the fingertips. The silicone tips do relieve fingertip creasing 160 but at the expense of the tactile feedback needed to feel the presence of strings and frets (FIG. 10A: Items F1, F2, etc.). Also, the silicone tips themselves do indent which gives them a high coefficient of friction to the strings. That makes musical slides impossible as well as inhibiting the use of “guide fingers” for position shifts. The silicone tips do not glide smoothly along strings.

Prior art FIG. 18 is a form of rubberized material. Fingertip creasing 160 is relieved. As with the device of FIG. 17 above, the covered fingers do not glide smoothly along strings. The musically expressive devices of grace notes, slides and trills are impossible.

FIG. 19 is representative of the many performance gloves on the market. Close inspection of their fingertips reveals a tightly woven synthetic fiber. There is minimum relief of fingertip creasing 160.

The present inventor has recognized that it would be desirable to provide a finger protector device that was easy to use, effective to protect fingers during guitar play and that overcame problems in the prior art.

### SUMMARY

A finger-protector device for guitar play includes a shell formed as a tube with an open base end and a substantially closed distal end. The finger-protector device is sized and shaped to fit tightly over a distal portion of a finger. The shell has a touch-hole on the distal end that is shaped to allow a guitar player to touch a selected guitar string with the fingertip. Preferably, the shell is substantially stiff in order to fret guitar strings. Preferably, the shell of the finger-protector device is composed of PETG plastic. A circumferential-edge can be provided surrounding the touch-hole to further assist fretting of a guitar string. The open base end comprises a substantially circular perimeter with an open area in the form of a cut-out extending from the substantially circular perimeter toward the distal end of the shell which provides some space between fingers for finger crowding requirements for playing certain chords.

The finger protector device is most applicable to nylon string guitars with traditional classical string spacing as well as other nylon string guitars with the slightly narrower “cross-over” string spacing.

One finger protector device fits on each of the left-hand fingers of a player performing on a right-handed nylon string guitar.

The finger protector device is a finger cap custom fitted to the precise size and shape of each individual finger. It is thin preferably with less than 0.020 inch wall thickness. It is hard with a typical Shore A rating of 70. It fits tightly. It incorporates a touch-hole which allows the fingertip to peek through for the tactile feedback advantageous for performance. The contact point for fretting pressure comes from a circumferential-edge. The hard material of the finger protector device distributes fretting pressure over the entire fingertip preventing the fingertip creasing 160. The touch-hole need not be round; it may vary in size and shape.

Guitar players often need to squeeze their fingers tightly together for chord shapes. For an E major chord, the second and third fingers are crowded together. For this chord shape, any finger covering, including the finger protector device, prevents fingers from coming as close together as can bare fingers. The finger protector device includes two design approaches to address this problem. The cut-out is the approach taken by the first embodiment finger protector device. Alternative embodiment has a narrow-opening for a tight fit and is shorter than the first embodiment leaving more fingertip area uncovered to allow finger overlap for chords.

Numerous other advantages and features of the present invention will become readily apparent from the following detailed description of the invention and the embodiments thereof, from the claims and from the accompanying drawings.

### BRIEF DESCRIPTION OF THE DRAWINGS

FIG. 1A is a perspective view of an exemplary embodiment finger protector of the present invention;

FIG. 1B is a perspective view of a user wearing four of the finger protectors of FIG. 1A on one hand;

FIG. 1C is another perspective view of the finger protector of FIG. 1A;

FIG. 1D is another perspective view of a user wearing four of the finger protectors of FIG. 1A on one hand;

FIG. 2A is a perspective view of an alternate exemplary embodiment finger protector of the present invention;

FIG. 2B is a perspective view of a further alternate exemplary embodiment finger protector of the present invention;

FIG. 2C is a perspective view of a further alternate exemplary embodiment finger protector of the present invention;

FIG. 3A is a perspective view of impression molds and finger-castings from the impression molds.

FIG. 3B is a perspective view of a finger-casting pursuant to fabrication of alternate embodiment 2c.

FIG. 4A is a computer screen and image of a natural finger as captured by 3D scan equipment.

FIG. 4B is a computer screen and images of a 3D finger model at two stages of CAD (Computer Aided Design) processing pursuant to fabrication of the first embodiment.

FIG. 4C is a computer screen and 3D image of a taped finger as captured by 3D scan equipment.

FIG. 4D is a computer screen and images of a 3D model of a taped finger at two stages of CAD (Computer Aided Design) processing pursuant to fabrication of alternate embodiment 2c.

FIG. 5A is a perspective view of a 3D-printed thermoform-template pursuant to fabrication of the first embodiment;

FIG. 5B is a perspective view of a thermoform-template pursuant to fabrication of alternate embodiment 2c;

FIG. 6A is a perspective view of a plastic formed-shell formed over a thermoform-template;

FIG. 6B is an enlarged, fragmentary sectional view of a fingertip portion of a formed-shell;

FIG. 6C is a perspective view of a formed-shell in isolation pursuant to fabrication of the first embodiment;

FIG. 6D is a perspective view of a formed-shell in isolation pursuant to fabrication of alternative embodiment 2c;

FIG. 7A is a front side perspective view of fingers of the left hand with color marking;

FIG. 7B is a back side perspective view of the left-hand fingers with color marking;

FIG. 7C is a further front side perspective view of fingers of the left hand with color marking;

FIG. 8 is a fragmentary perspective view, shown partially in section, of the formed-shell placed over the second finger;

FIG. 9 is a perspective view of the left hand second fingertip wrapped with flexible medical tape;

FIG. 10A is an elevation view of a classical guitar;

FIG. 10B is a plan view of the classical guitar of FIG. 10A;

FIG. 10C is an elevation view of a guitar performer playing the classical guitar of FIG. 10A;

FIG. 11 is fragmentary perspective view of a classical guitar fitted with a long saddle;

FIG. 12A is a fragmentary plan view taken from FIG. 10B with performer fretting bare fingered;

FIG. 12B is a fragmentary plan view taken from FIG. 10B with the user wearing the finger protectors of FIG. 1A;

FIG. 13A is an enlarged elevation view taken from FIG. 10C with performer bare first finger fretting high-E-string;

FIG. 13B is an enlarged further elevation view taken from FIG. 10C with performer bare third finger fretting high-E-string;

FIG. 14A is an enlarged further elevation view taken from FIG. 10C with performer's first finger wearing the finger protector of FIG. 1A to fret high-E-string;

FIG. 14B is an enlarged further elevation view taken from FIG. 10C with all four performer's fingers wearing the finger protectors of FIG. 1A to fret high-E-string;

FIG. 14C is an enlarged perspective view taken from FIG. 10C with the performer executing a G chord formation wearing the finger protectors of FIG. 1A;

FIG. 15 is an enlarged further elevation view taken from FIG. 10C with the performer executing an A chord formation wearing the finger protectors of FIG. 1A;

FIG. 16 is a perspective view of creases which appear in fingertips from performing on guitar without use of the finger protector;

FIG. 17 is a perspective view of a prior art finger protector;

FIG. 18 is a perspective view of another prior art finger protector;

FIG. 19 is a prior art glove finger protector.

### DETAILED DESCRIPTION

While this invention is susceptible of embodiment in many different forms, there are shown in the drawings, and will be described herein in detail, specific embodiments thereof with the understanding that the present disclosure is to be considered as an exemplification of the principles of the invention and is not intended to limit the invention to the specific embodiments illustrated.

Illustrations and text refer only to performance by a right-handed guitar player, for simplicity of description. It is equally applicable to left-handed guitar players with modification to the device.

This application incorporates by reference U.S. Provisional Patent Application Ser. No. 63/617,708, filed Jan. 4, 2024 in its entirety.

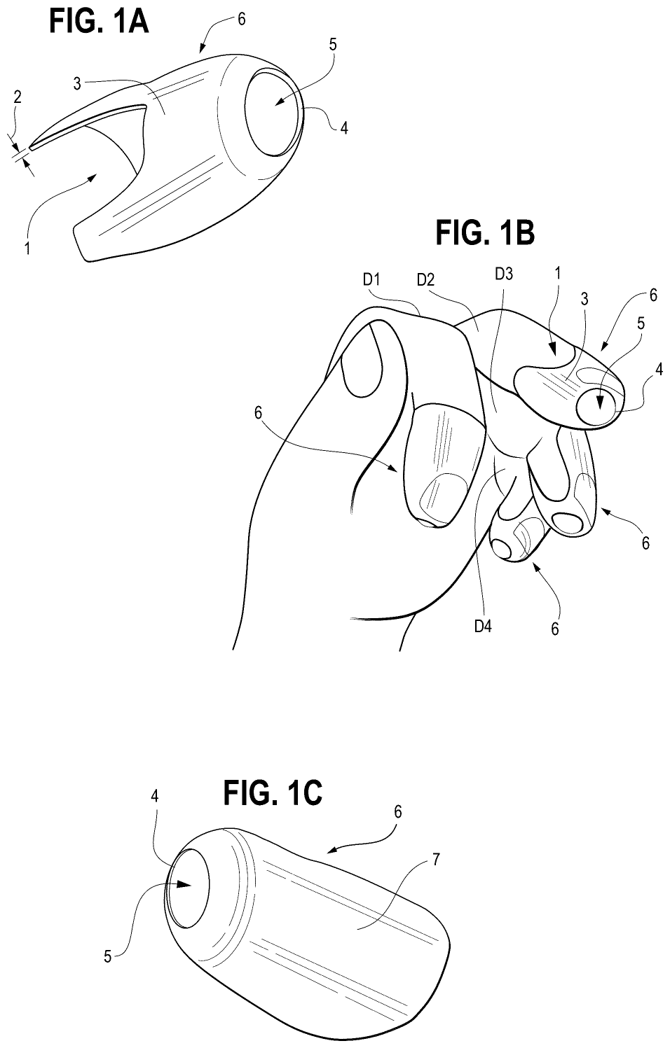

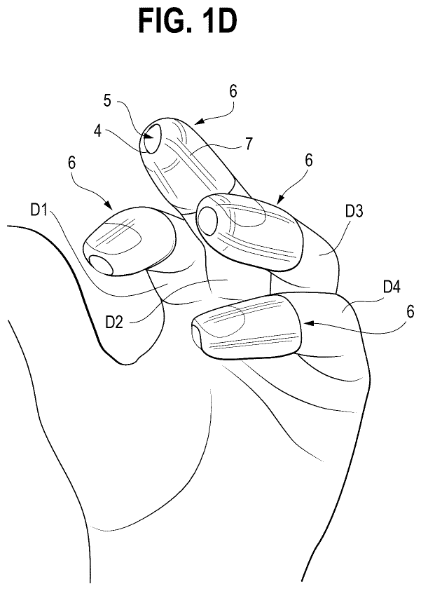

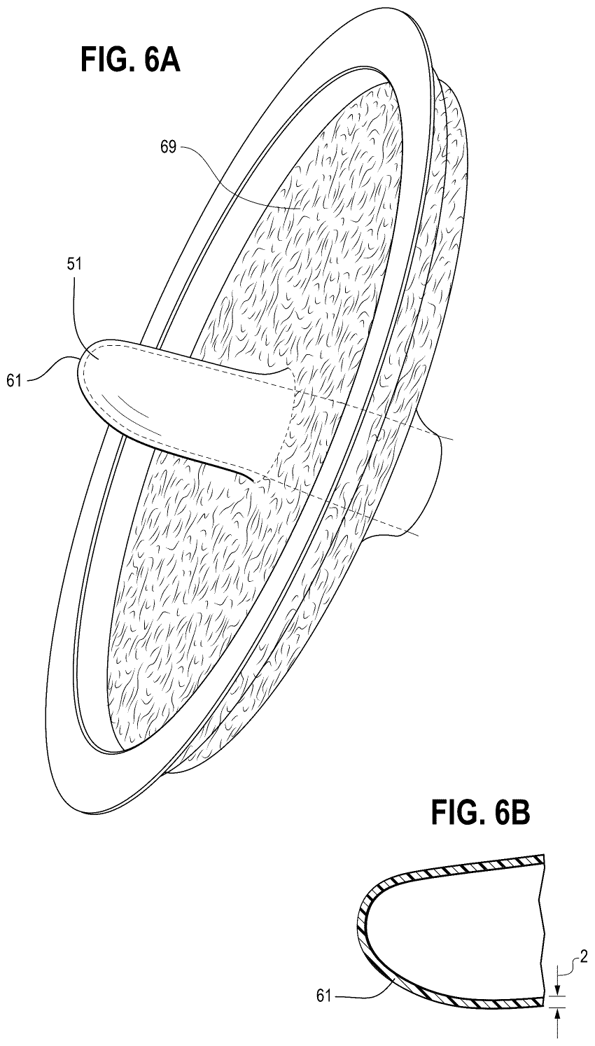

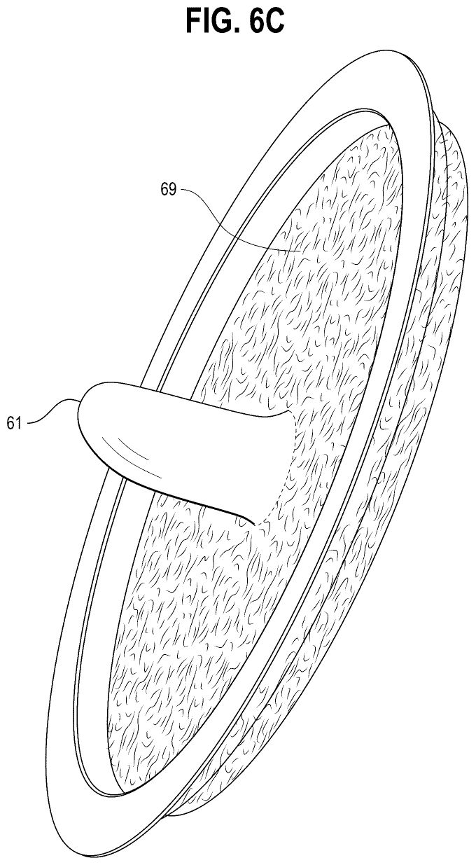

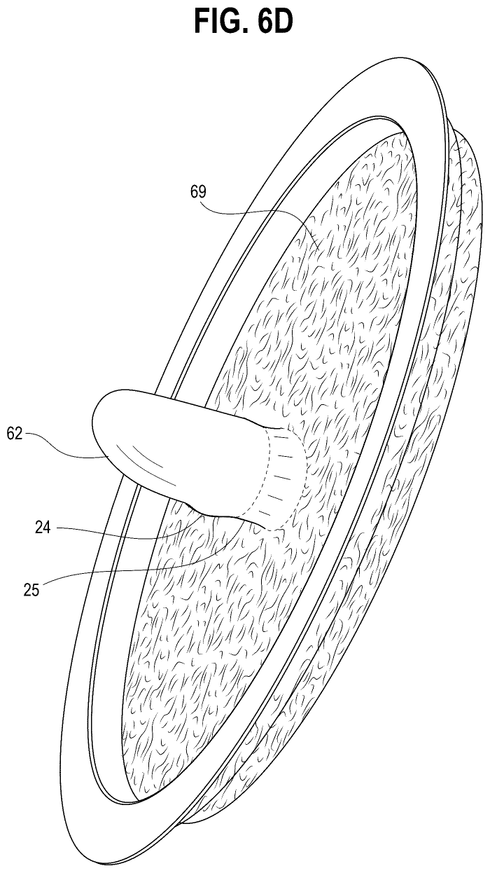

FIG. 1A shows a first embodiment finger protector device 6 comprising a formed-shell 61 (FIG. 6C) in the form of a tube. The first embodiment can be constructed from PETG plastic. PETG plastic has a typical Shore A harness rating of 70. Other stiff materials are also encompassed by the invention.

An open area in the form of a cut-out 1 (FIG. 1A) is provided through the finger protector device 6. Referring to FIGS. 6A and 6B, the finger protector device formed-shell 61 can have a wall thickness 2 which can measure 0.015 inches. The shape of the finger protector device 6 and its wall thickness come directly from formed-shell 61. Wall thicknesses 2 that vary from 0.015 inch are also encompassed by the invention.

Referring to FIG. 1B, on a thumb side of the finger protector device 6, a surface region 3 is included, being a surface closest to the thumb when the finger protector device 6 is mounted on a left-hand finger, as exemplified by the second finger (D2) in the figure. In this embodiment, the cut-out 1 is located on the thumb-side. Other embodiments may place a cut-out on the opposite side of finger protector device 6 and may include more than one cut-out or no cut-outs at all.

A circumferential-edge 4 (FIG. 1A) is provided on the finger protector device 6. The circumferential-edge may be flush with the outer surface of the tip of the device 6 or can be raised. The circumferential-edge 4 can be a circular boarder of a touch-hole 5. Other embodiments may have strength reinforcement composed of other materials, possibly metallic, extending in a ring around the circumferential-edge 4 or around the touch-hole 5.

The touch-hole 5 (FIG. 1A) is a circular opening which can have a diameter of 0.30 inches at the apex of the fingertip. Other embodiments may have any hole dimension, any hole shape and the hole may be located anywhere on the formed-shell 61.

FIG. 1B shows plural finger protector devices 6 mounted on all four fingers (D1, D2, D2, D4) of a left hand. To keep the drawing uncluttered, finger protector device 6 features are only indicated on the second finger (D2). The second finger shows an example of the thumb-side 3 having the cut-out 1. The circumferential-edge 4 and a touch-hole 5 are also shown in FIG. 1B.

FIG. 1C shows the finger protector device 6 as viewed from the pinky finger. Pinky-side surface region 7 is the surface region which is closest to the pinky finger when the finger protector device 6 is mounted on a left-hand finger.

FIG. 1D shows the finger protector devices 6 mounted on all four fingers of the left hand. To keep the drawing uncluttered, item features are only indicated on the second finger (D2) such as the circumferential-edge 4 and the touch-hole 5. Notice that the pinky-side surface 7 of the finger protector device 6 does not have a cut-out 1. Other embodiments of finger protector device 6 may well have a cut-out 1 on the pinky-side.

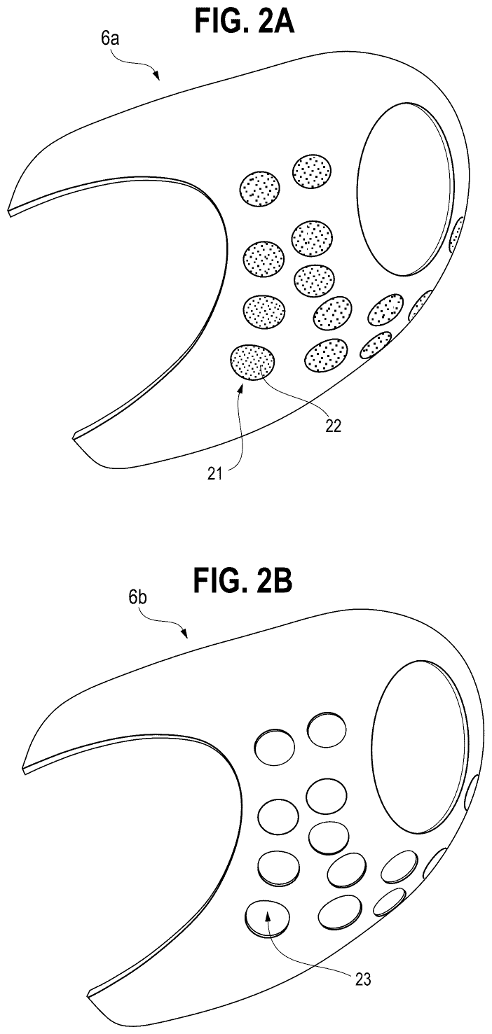

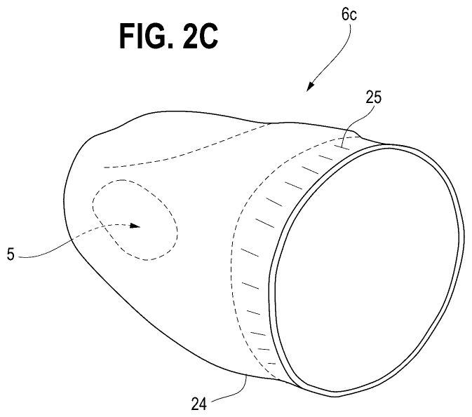

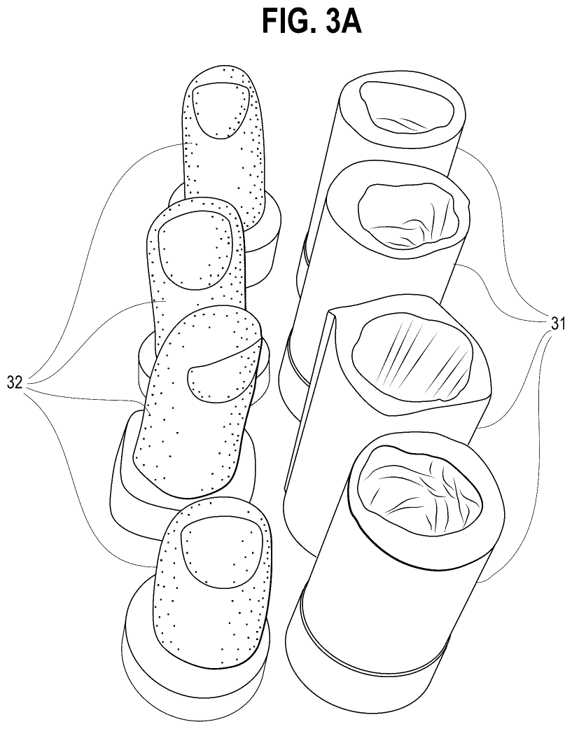

FIG. 2A is an alternate embodiment finger protector device 6a including grit-patches 21. One or more grit-patches 21 may be located anywhere on the finger protector device 6a. The grit-patch may include grinding compound 22 possibly 80 Grit Aluminum Oxide. Alternate embodiments may use any grinding compound of any grit placed in any manner. The finger protector device 6a is in all other regards the same as the finger protector device 6.

FIG. 2B is a further alternate embodiment finger protector device 6b in which grip-holes 23 are drilled into, cut into, or formed into the finger protector device 6b. The open grip-holes 23 may be of any size and at any location on finger protector device 6b. The finger protector device 6b is in all other regards the same as the finger protector device 6.

FIG. 2C is a further alternate embodiment finger protector device 6c which is reduced in length relative to the first embodiment finger protector device 6. The cross-sectional area, bounded by the finger protector device, along the length of finger protector device changes. At the touch-hole 5, the cross-sectional area is a minimum. At a bulge 24, the cross-sectional area is a maximum. The remaining length of the finger protector device 6 has a ring-like shape and reduced cross-sectional area to fit tightly on player's finger. This portion of finger protector is identified as indent-region 25 in FIG. 2C; it encompasses 20% of total length of the finger protector 6.

Embodiment 6c may or may not contain cut-out 1; it retains the touch-hole 5 and circumferential-edge 4. The finger protector device 6c is in all other regards the same as the finger protector device 6.

### Method of Making

### Fabrication of the First Embodiment

The Finger protector device design does not prefer either right-handed or left-handed play. For brevity, assume that the following fabrication discussion applies to finger protector devices for the left-hand fingers of a guitar player performing on a right-handed instrument.

Complete fabrication of the first embodiment 6 is described immediately below followed by process modifications and additions to create alternate embodiments 6a through 6c.

Be advised that 3D scanning and 3D printing are evolving rapidly. By the time this document is read, better ways of accomplishing the fabrication steps below may have arrived.

As the finger protector devices 6-6c are constructed of stiff material, they must be precisely sized and shaped for each individual finger. If too small, they cannot expand; if too loose, they will shift out of position during performance.

To keep the drawings uncluttered, the figures show fabrication steps applied to second finger (D2) but the same steps apply equally to the other left-hand fingers.

The initial goal is to obtain a 3D scan of each finger. At present, 3D scanners do not have image stabilization and are relatively slow so it is impossible to hold a finger motionless for sufficient time to complete a high-resolution 3D scan. Thus, there can be a preliminary step. A physical model of each finger is created to remain motionless during 3D scanning.

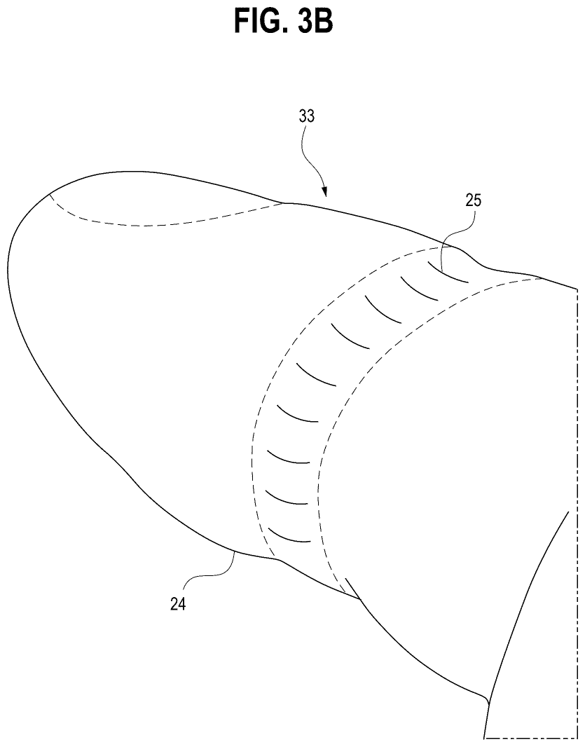

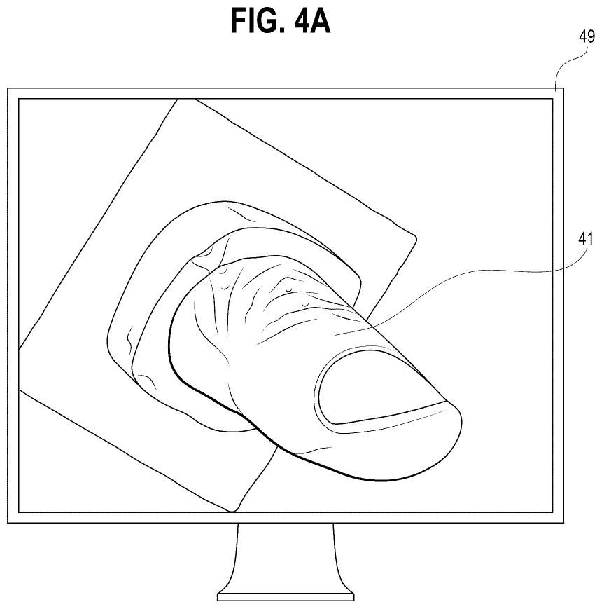

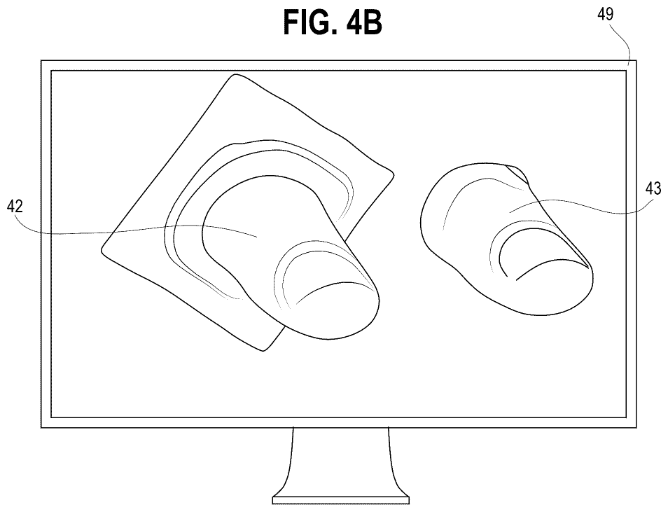

The same impression material used by dentists serves here to make impressions of each left-hand finger; Aquasil® Ultra XLV Regular Set is a good choice. FIG. 3A shows four such impression molds 31. For the finger-castings 32 dental technology die stone is a simple powder plus water mix with excellent dimensional accuracy which may be poured into impression molds 31.

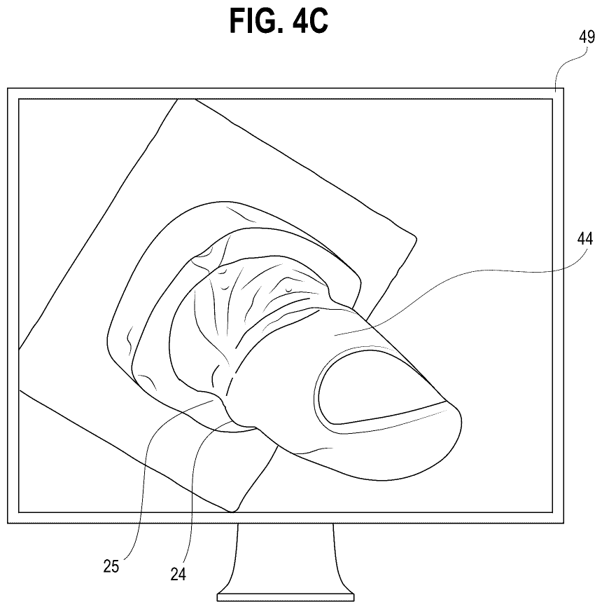

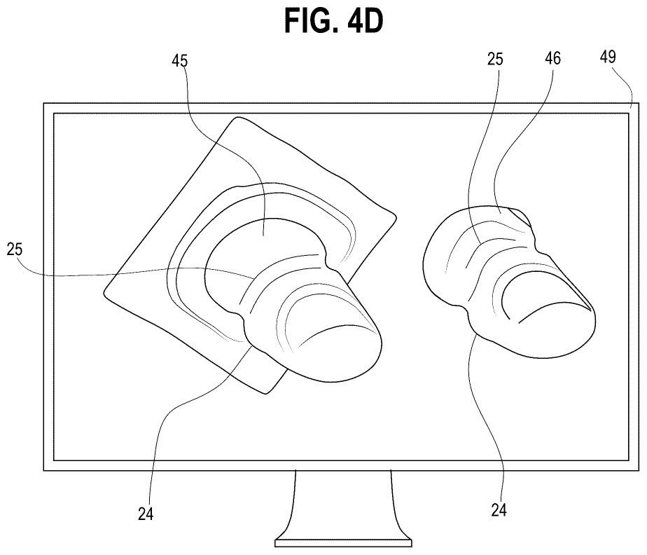

The finger-castings 32 are exact physical models of the human finger. They are 3D scanned to yield a CAD (Computer Aided Design) computer model file for each finger. FIG. 4A shows a computer screen 49. Visible on that screen is CAD-raw 41, which is the 3D image rendering, a computer model, of finger-casting 32.

Applying CAD editing, including smoothing operations, to CAD-raw 41 removes casting bubbles and skin wrinkles to produce CAD-Smoothed 42 shown in FIG. 4B. Meshmixer® is a free 3D CAD editing program offered by Autodesk®. All the CAD editing to create CAD-smoothed 42 is done in Meshmixer® with the exception of surface smoothing. For smoothing operations, the Poisson algorithm of Meshlab® is best. Meshlab® is a free 3D CAD editing program maintained by volunteers.

FIG. 4B illustrates a computer screen 49. For the First Embodiment 6 to fit tightly, its volume can be slightly smaller than that of the natural finger. That is the motivation for creating CAD-shrunk 43 smaller than CAD-smoothed 42, both seen in FIG. 4B

The amount of size reduction from CAD-smoothed 42 to CAD-shrunk 43 varies widely from person to person and can only be determined by trial and error. A 0.99 reduction factor applied to each of the 3 linear axes of CAD-smoothed 42 would result in a 3% reduction in volume of CAD-shrunk 43.

A computer model can be oriented relative to coordinate axes of a CAD system in any number of ways. For discussion here assume that the length of the finger is in line with the Z-axis. The 3% figure above is a rough estimate and the Z-axis shrinkage may differ from that of the other two axes.

If the remaining fabrication steps cannot be executed in CAD, vacuum thermoforming and positive pressure thermoforming are advantageous processes capable of fabricating plastic in small wall thicknesses 2.

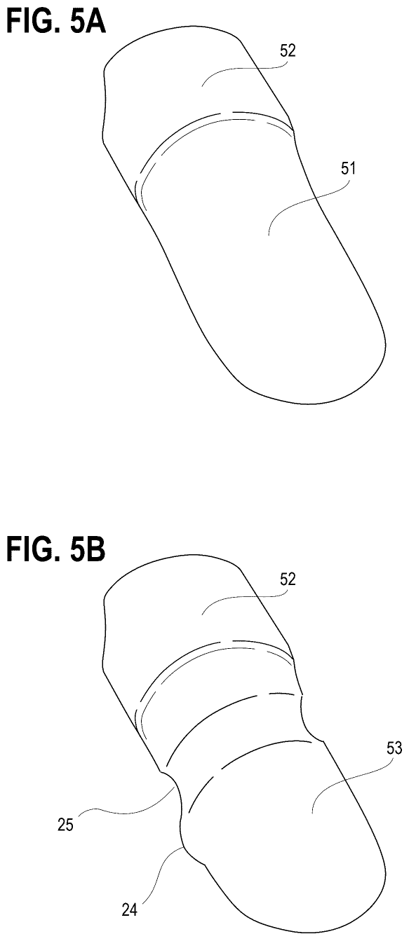

Thermoforming machines used by the dental industry for creating mouth guards are an ideal size for producing single embodiments of finger protector devices 6-6c. The thermoform process consists of stretching a thin, hot, circular plastic sheet over a smooth template. In mouth guard dentistry that template is a physical casting of human teeth. For first embodiment 6 and alternate embodiments 6a and 6b that template is the thermoform-template 51 of FIG. 5A.

For the first embodiment protector device 6, a 3D print of CAD-shrunk 43 becomes the physical thermoform-template 51 but first a base compatible with thermoform equipment is created and attached in CAD. FIG. 5A shows the 3D-printed thermoform-template 51 with attached template-base 52.

Stereo lithography (SLA) 3D-printing is recommended for thermoform-template 51 as it offers solid construction and excellent accuracy. Accura PEAK™ is one of many excellent resins which yield a thermoform-template that can endure high temperature and the cutting operations to follow.

By common physics, the maximum pressure that a vacuum thermoforming machine can achieve over a thermoform-template is limited to the atmospheric pressure of 14.7 pounds/square inch (psi). For the best adherence, plastic-to-template, positive pressure thermoforming is preferred. The German-built MiniSTAR® S is an excellent choice with its 60 psi positive pressure rating.

Regarding source of thermoform plastic, a good beginning thermoplastic is 0.020″ Vivak® PETG sheet stock. Other embodiments may use other types of thermoform plastic or other stiff materials altogether.

The high-temperature/high-pressure of the thermoform process leaves a thin plastic shell covering a template. For the first embodiment 6, FIG. 6A shows formed-shell 61 covering thermoform-template 51. Notice the pie-shaped excess plastic 69 which is discarded; it is a byproduct of the thermoform process. The formed-shell 61 appears in isolation in FIG. 6B once the thermoform-template 51 (FIG. 5A) is removed.

The excess plastic 69 of FIG. 6C is unavoidable waste from thermoform fabrication.

For the First Embodiment finger protector device 6, wall thickness 2 will become about 0.015 inches due to stretching of the 0.020 inch PETG sheet stock. The finger protector devices 6-6c may have various wall thicknesses. Wall thickness may vary over different areas of protector devices 6-6c.

The result of any thermoforming operation is a smooth shape with no holes as formed-shell 61 (FIG. 6B) clearly demonstrates. Thermoforming can only create shapes which can hold water. Thus, features such as a cut-out 1 or a touch-hole 5 (FIG. 1A) are carved out of the physical plastic of formed shell 61 after thermoforming.

Alternatively, if 3D printing is used, computer editing of CAD-shrunk creates the thin shell 61 (FIG. 6C) with the cut-out 1 and touch-hole 5 (FIG. 1A). The finger protector device 6 can then be 3D printed directly avoiding thermoforming and the waste of excess plastic 69.

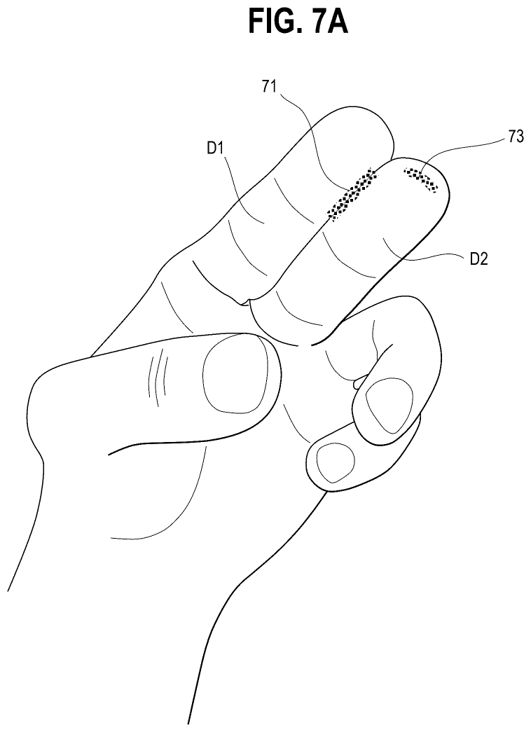

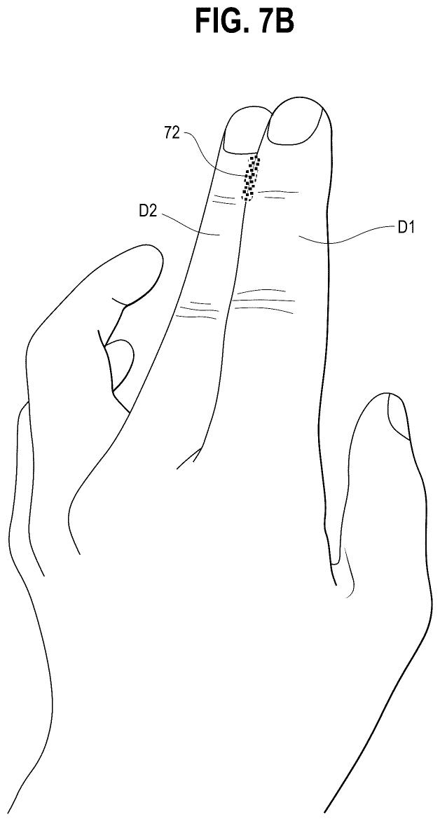

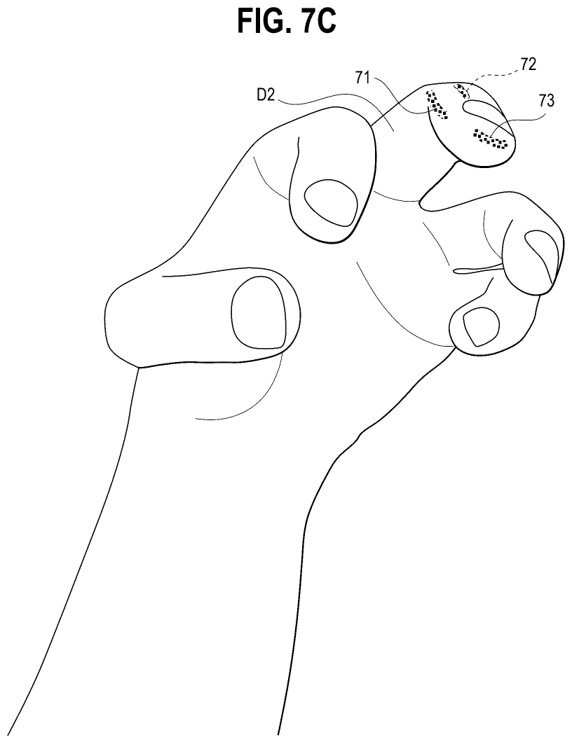

If thermoforming is used to produce formed-shell 61 (FIG. 6B). Further processing of formed-shell 61 commences with marking the target finger to guide the cutting, grinding and drilling required. The second finger shall be the example. As in FIG. 7A, the first and second fingers are held together with the second finger (D2) slightly in front of first finger (D1). A Sharpie® permanent marker is used to color where fingers come together as in FIG. 7A; the marking is referred to as mark-2nd-front 71. Inevitably, Sharpie® marking will appear on both first and second fingers although no use is to be made of marking on the first finger (D1).

As in FIG. 7B, first and second fingers are held together with the second finger (D2) slightly in front of the first finger (D1). A Sharpie® Permanent Marker is used to color where the fingers come together as in FIG. 7B; the marking is referred to as mark-2nd-rear 72. Again, Sharpie® marking will appear on both the first and second fingers although no use is to be made of marking on the first finger (D1).

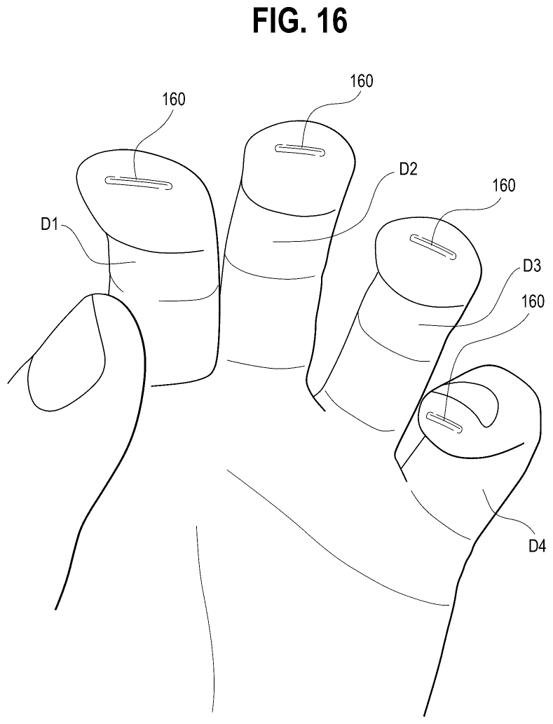

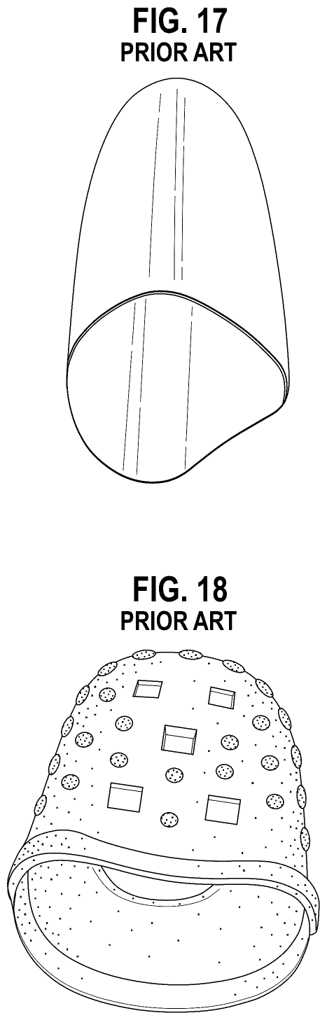

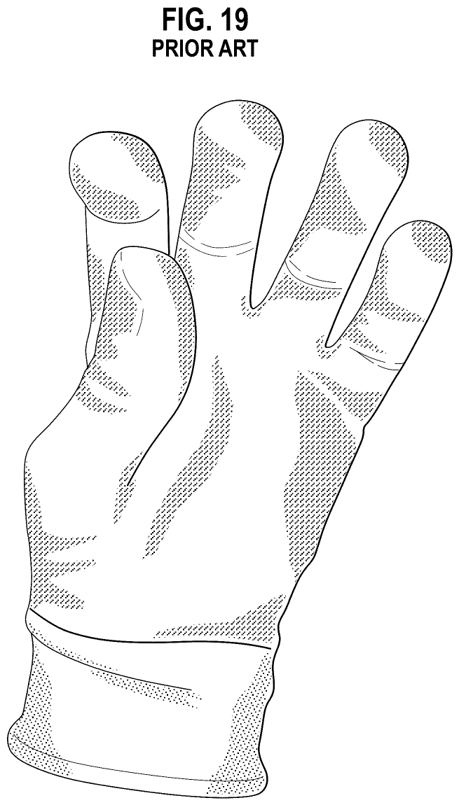

Guidance is needed for placement of the touch-hole 5. A common musical chord is chosen which utilizes the second finger. The chord is held tight. There should now be a crease 160 (FIG. 16) in the second finger (D2). A Sharpie® is used to mark-2nd-tip-crease 73 as seen in FIG. 7A.

As shown in FIG. 7C, the second finger (D2) is now marked with the following: mark-2nd-front 71, mark-2nd-rear 72, mark-2nd-tip-crease 73. With these markings on the second finger, it is inserted into the formed-shell 61 (FIG. 6B) and the shell is marked where cuts need to be made.

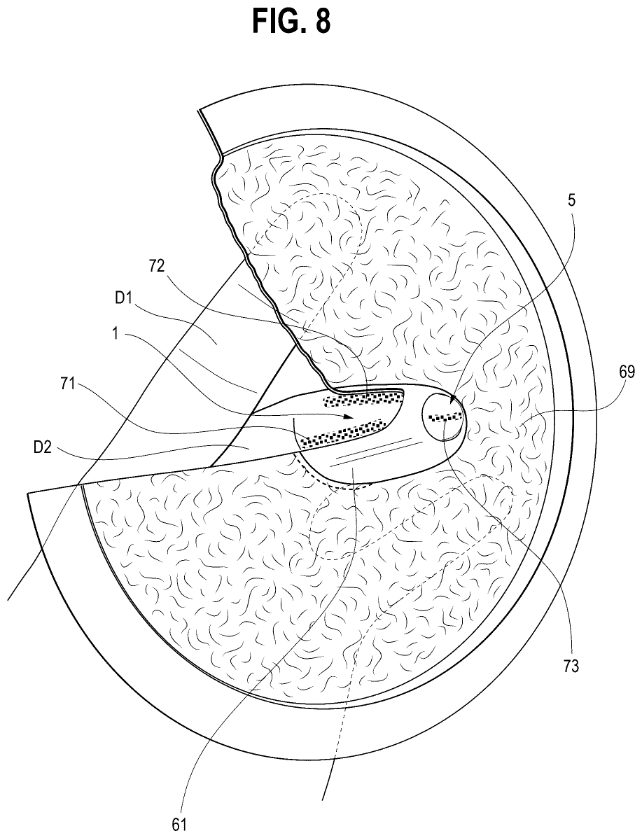

Conventional plastic cutting and grinding technology is used to implement the side cut-out 1 and touch-hole 5 as in FIG. 8. FIG. 8 shows second finger (D2) inside formed-shell 61. The finger should never be within the formed-shell 61 (FIGS. 6B and 8) during cutting and grinding due to the possibility of injury. The finger should only be thus inserted to check progress of cutting and grinding operations.

Once plastic sections for the cut-out 1 and touch-hole 5 have been removed, as seen in FIG. 8, remaining excess plastic 69 can be discarded.

It is highly likely that players will desire to experiment with the size, shape and location of the touch-hole 5. A guitar player with a minimum of mechanical skill and a DREMEL® tool with grinding bit can widen the touch-hole himself. Such a player may want to acquire finger protector device 6 with a small touch-hole 5 and grind to enlarge to his own preferred shape and size. Fractions of a millimeter in the touch-hole 5 make a noticeable difference in playing feel.

### Fabrication of Alternate Embodiment

As seen in FIG. 2A, alternate embodiment 6a has grinding compound 22 attached in grit-patches 21 onto a first embodiment 6 base. Grinding compound may be affixed with glue or press techniques. Grinding compound may be distributed anywhere on plastic surface. Grinding compound may be similarly affixed to alternate embodiment 6c.

As seen in FIG. 2B alternate embodiment 6b has grip-holes 23 drilled into plastic skin of first embodiment 6 base. Conventional drill or punch techniques are sufficient. Grip-holes 23 may also be drilled into alternate embodiment 6c.

Alternate embodiment 6c is shown in FIG. 2C. Cut-out 1 is absent in the drawing although it may or may not be present in realization of embodiment 6c. Embodiment 6c has indent-region 25 identified in FIG. 2C which aids in keeping embodiment tightly attached to performer's finger. Indent-region 25 is the defining feature of alternate embodiment 6c.

There are three fabrication sequences for producing alternate embodiment 6c. The sequences differ in the extent to which CAD (Computer Aided Design) is used. The first fabrication sequence presented does not utilize any CAD (Computer Aided Design). Hence the resultant alternate embodiment 6c may not have an exact fit.

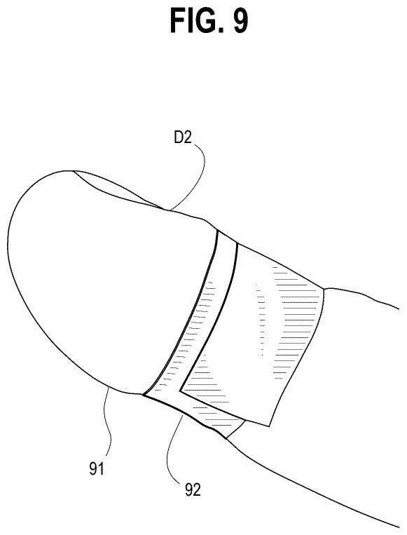

The strategy begins with modifying the shape of the natural finger. In FIG. 9 tape 92 surrounds the second finger D2 from first knuckle up to 20% of fingertip length. Tape 92 should have elastic characteristics. 3M Nexcare™ flexible clear tape is a good choice. Tape 92 is applied with very little tension. Even gently applied tape 92 will reduce the cross-sectional area of the human finger beneath and create a bulge-in-finger-pad 91. The human finger resembles a water bladder. When squeezed, it bulges elsewhere and hence the bulge-in-finger-pad 91 (FIG. 9).

With tape 92 applied, the identical dental impression material used in creation of first embodiment 6 (Aquisil Ultra™ XLV Regular Set) serves here to create a mold 31 (FIG. 3A). FIG. 3A serves for the alternate embodiment even though the interior of mold 31 has shape here conforming to the second finger (D2) of FIG. 9.

In creation of the first embodiment 6 the casting material poured into molds 31 is dental die stone which cures to a hard solid. For fabrication of alternate embodiment 6c, the alternate-casting 33 (FIG. 3B) should be compressible and flexible. A good material is two-part polyurethane elastomer from BJB Materials with part number F160. It has flexibility of Shore A hardness 60. Alternate-casting 33 (FIG. 3B) is a replica of taped finger D2 as seen in FIG. 9. Notice alternate-casting 33 indent-region 25 (FIG. 3B) corresponds to where tape 92 reduces the cross-section of natural second finger D2 (FIG. 9). Similarly alternate-casting 33 bulge 24 (FIG. 3B) corresponds to the bulge-in-finger-pad 91 of natural second finger D2 (FIG. 9).

Continue with the fabrication of alternate embodiment 6c done without CAD. Alternate-casting 33 (FIG. 3B) serves as a thermoform-template in the same manner as thermoform-template 51 (FIG. 5A) for the first embodiment 6. The result is indented-formed-shell 62 of FIG. 6D. The indented-formed-shell 62 has bulge 24 and indent-region 25 from being formed over alternate-casting 33. The reason alternate-casting 33 should be made of flexible Shore A hardness material is now apparent. Directly after the thermoforming operation, alternate-casting 33 (FIG. 3B) is inside indented-formed-shell 62 (FIG. 6D). As alternate-casting 33 is removed from indented-formed-shell 62, the bulge 24 of casting 33 should compress (or the shell expand) to fit through the indent-region 25 of indented-formed-shell 62.

The same plastic cutting and drilling operations used for the first embodiment 6 are identically applied here to carve out touch-hole 5 (FIGS. 2C and 1A). Cut-out 1 (FIG. 1A) is not carved although realizations of alternate embodiment 6c may or may not have cut-out 1. The result is seen in FIG. 2C as alternative embodiment 6c fabricated without CAD.

The second fabrication sequence for alternate embodiment 6c is identical to the first through several steps. Begin by modifying shape of the natural finger with tape 92 (FIG. 9) and continue first sequence steps through realization of alternate-casting 33 (FIG. 3B).

Diverging from the first fabrication sequence above, a 3D scan of alternate-casting 33 is created as alternate-CAD-raw 44 seen in FIG. 4C with identifying features of bulge 24 and indent-region 25. Alternate CAD-raw 44 is analogous to CAD-raw 41 (FIG. 4A) of the first embodiment in that the same CAD edits applied to CAD-raw 41 are here applied to alternate-CAD-raw 44. FIG. 4B illustrates that progression of CAD edits for the first embodiment. FIG. 4D illustrates the analogous edit progression for alternate embodiment 6c. Observe alternate-CAD-smoothed 45 to alternate-CAD-shrunk 46 in FIG. 4D with identifying features of bulge 24 and indent-region 25.

Depending upon thermoform equipment it may be necessary to increase the length of alternate-CAD-shrunk 46 by adding a base to CAD model alternate-CAD-shrunk 46. With that the desired thermoform-template is in hand as a CAD model which needs to be realized as a physical, flexible piece. If stereo lithography (SLA) 3D printers could produce a solid, flexible shore A hardness template, that would be the next step. At this time, SLA printing of flexible materials is in its infancy. Filament 3D printers are so capable but their output is not solid; it has internal voids. A thermoform-template with internal voids will shrink under a positive pressure thermoforming operation which is not acceptable.

The only choice is to SLA 3D print alternate-CAD-shrunk 46 in a hard material such as Accura PEAK™. The result is seen in FIG. 5B with alternate-thermoform-template 53 being the physical realization of alternate-CAD-shrunk 46. Template-base 52 may be necessary to adapt to thermoform equipment.

An exact copy of the just-printed alternate-thermoform-template 53 should be made of a flexible material. Alternate-thermoform-template 53 is immersed in a low viscosity silicone mold-making material such as BJB Materials TC-5130. After curing time, the alternate-thermoform-template 53 is removed leaving a mold imprinted in the hardened TC-5130. BJB Materials F160 poured into that mold creates an exact replica of alternate-thermoform-template 53 in the needed flexible form. With the now-flexible alternate-thermoform-template 53 in hand fabrication proceeds as with the first embodiment 6.

Fabricators with considerable CAD skill may prefer a third fabrication sequence. Begin with CAD-raw 41 (FIG. 4A) which is and accurate computer model of the human finger. Adjust Z axis to align with length of the finger. Create plane cut slices perpendicular to the Z axis. Reduce the Z-axis dimension of those slices. The CAD model now has the appearance of ribs outlining the shape of a finger. Create the indent-region 25 by reducing the cross section of selected ribs. Enclose the ribs with two-dimensional surface construction to produce a CAD model to resemble alternate-CAD-raw 44 (FIG. 4C). Apply Meshlab™ or similar smoothing operation as for first embodiment 6 to produce alternate CAD-smoothed 45 (FIG. 4D). Depending the processing of the cross-sectional ribs it may or may not be necessary to further shrink the CAD model to produce an alternate-CAD-shrunk 46 (FIG. 4D). 3D print the model in hand. Create an identical physical copy in flexible material. Thermoform and proceed as with the first embodiment 6 except that cut-out 1 (FIG. 1A) is not carved.

### Method of Using

### Getting the Guitar Ready

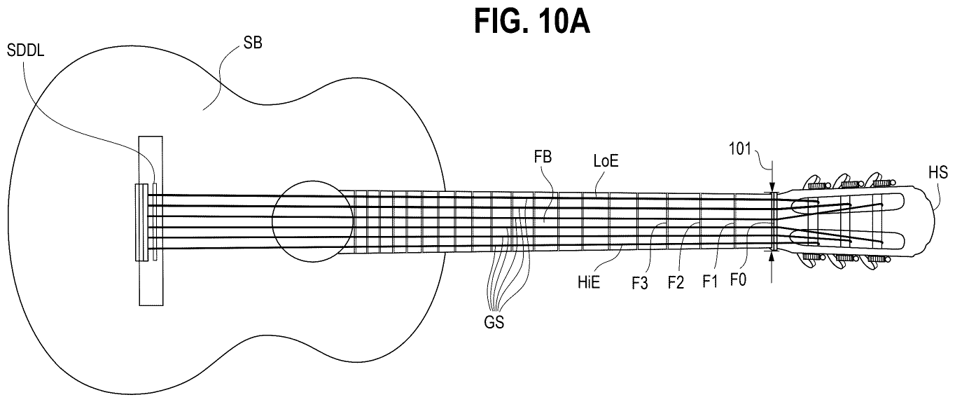

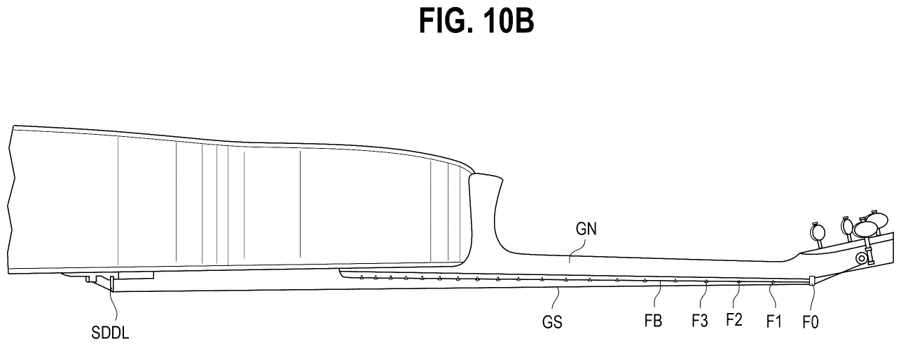

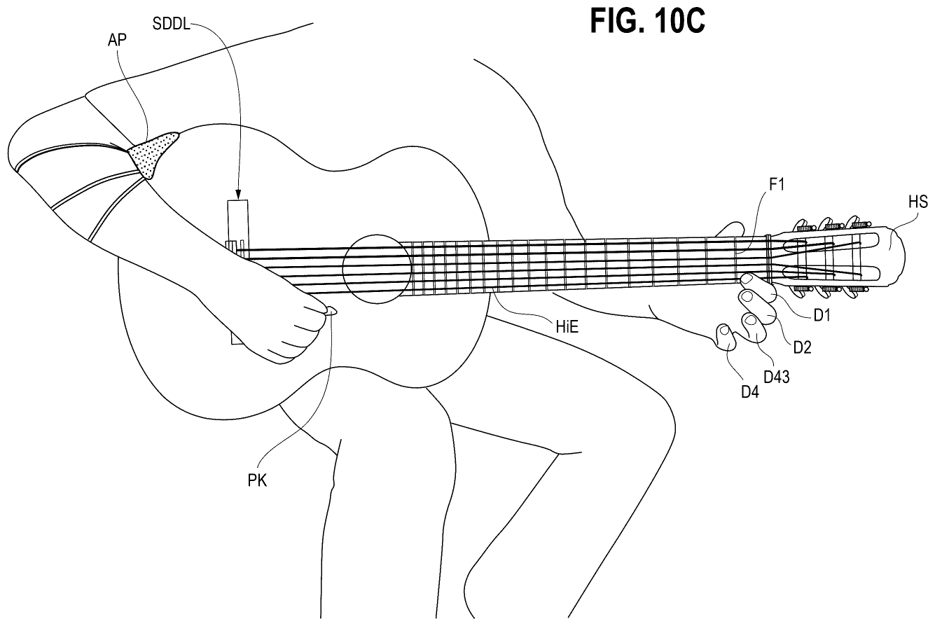

Finger protector development and testing has focused on nylon string classical guitars of 2 inch F0-Width 101 (FIG. 10A) and “crossover” guitars of 1⅞ inch F0-Width 101. By necessity, these instruments have higher action than electric guitars. This to accommodate the wide string vibration envelope required to achieve unamplified volume. Both these types will be referred to simply as classical guitars.

The features of finger protector devices could well be adapted toward embodiments for other stringed instruments. Initial candidates would be upright base, cello, and viola for their wide string spacing.

Beginners may not be aware that there are two standard scale lengths for the classical guitar. The scale length is the measured distance between the two string anchor points seen in FIG. 10A as fret 0 (Item F0) and saddle (Item SDDL). The majority of instruments sold are 650 mm but it is not hard to find quality 640 mm instruments. For players with small hands the 640 mm choice demands less stretching of the fingers and presents lower string tension.

Before attempting to use the finger protector device, the player should confirm that his instrument is in the best possible condition. This may require a visit to a reputable luthier. Classical guitars can have anomalies such as warped or twisted guitar necks GN (FIG. 10B), worn frets, or truss rod miss-adjustment.

A cause for concern even on perfectly serviceable instruments Is the playing “action.” Guitar players use the term “action” to refer to the height of the strings above the fingerboard FB (FIG. 10B). In FIG. 10B, the viewing angle is such that all the strings appear as a single string. The action of the guitar in FIG. 10B increases with increasing fret number. This is necessary to allow room for the strings to vibrate freely. The term guitar “action” or “action height” is also used to refer to adjusting (raising or lowering) the strings relative to the fingerboard.

A classical guitar with relatively high action allows more forceful right-hand plucking (or picking) of strings while maintaining tone without incidental buzzing of the strings. This is at the expense of much more left-hand effort and stress. Only a very small percentage of players have the hand strength to handle high action up and down the fingerboard FB (FIG. 10A).

Most amateur players want the action to be as low as possible without buzzing. Even with that adjustment many aspiring players never reach their expectations as their hands cannot survive enough practice time to become proficient.

A few thousandths of an inch in action height makes a noticeable difference in the difficulty of play. An experienced player can evaluate his guitar action by feel whereas an amateur has little to go by in evaluating his instrument.

Very expensive guitars can have high action right out of the box. Also, humidity can affect the action of a guitar. In the summer humidity, the guitar soundboard SB (FIG. 10A) absorbs moisture and bulges causing action to raise. Then in the dry winter months the soundboard shrinks back to become flatter lowering action.

With so many variables affecting action height, a visit to a luthier can be especially valuable for a beginning player who has not developed playing feel and cannot tell whether playing difficulty is himself or his guitar.

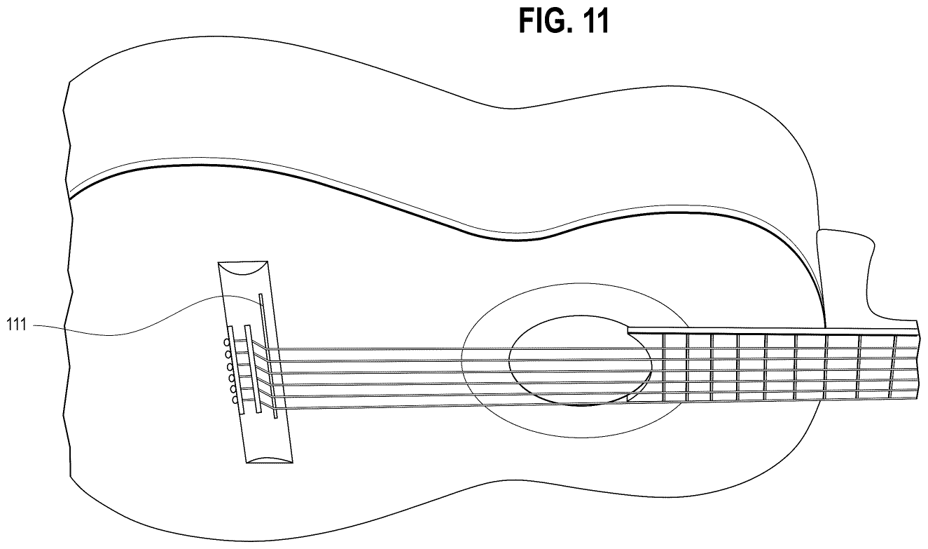

Guitar maker Michael Thames of New Mexico has a YouTube segment in which he suggests classical instrument owners request their instrument-set-up luthier provide a long saddle 111 (FIG. 11). With the long saddle a player can loosen strings and shift it himself to adjust action.

Legendary Spanish guitar maker Ignacio Fleta (1897-1977) invented the concept of an adjustable long saddle 111 (FIG. 11). It has the minor disadvantage that the intonation cannot be micro adjusted. For amateur players that concern takes a back seat to the ability to adjust guitar action at home as seasons change.

Some players have a classical guitar but have found that their hands are too small for the wide string spacing. A good luthier can narrow that spacing down from the classical to the narrower cross-over dimensions. Fashioning a narrower fret 0 (FIG. 10A: Item F0) is straight forward. The saddle SDDL (FIG. 10A) will need shallow notches to bring the strings closer.

### Solid Playing Mechanics

Playing and practicing with a finger protector device will be most successful for players who adopt the basic principles of holding the guitar firmly in a stable position so that the left hand can press and slide on strings without thumb or palm counter pressure to the guitar neck GN (FIG. 10B). The classical guitar seating position with the guitar on the opposite leg is the ultimate example but players who mount on the near leg and use an arm pad AP (FIG. 10C) can get equivalent mechanics. The finger pressure to fret strings comes from the muscles at the back of the left shoulder pulling the hand toward the fingerboard FB (FIG. 10A). That force is counter balanced with chest pressure to the guitar body and downward right arm pressure on the body of the guitar. The right arm pressure to the guitar body can be made comfortable with arm pad (FIG. 10C: Item AP). The thumb does not participate in force mechanics, staying relaxed and providing a sense of orientation.

### Using the Finger Protector Device

Finger protector devices 6 better adhere to fingertips when dipped in water prior to mounting.

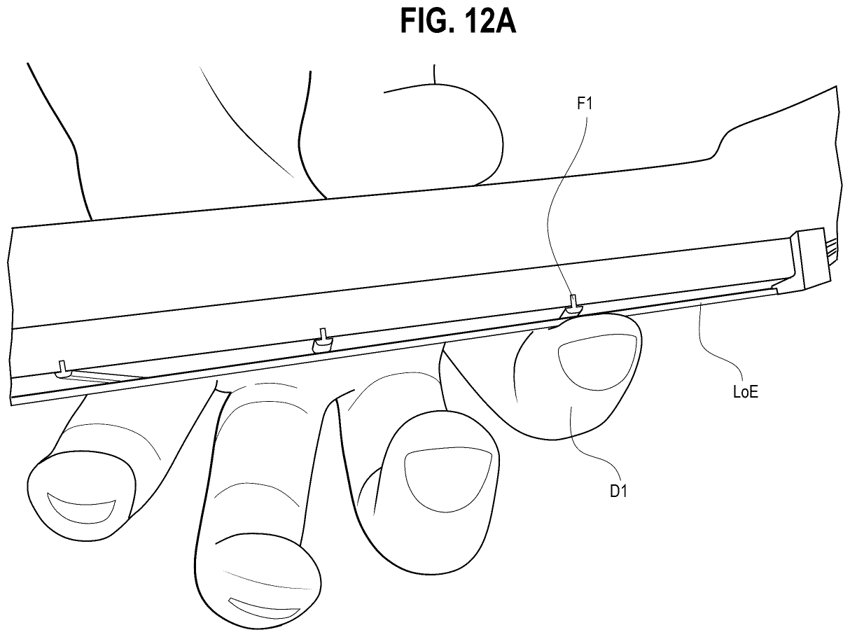

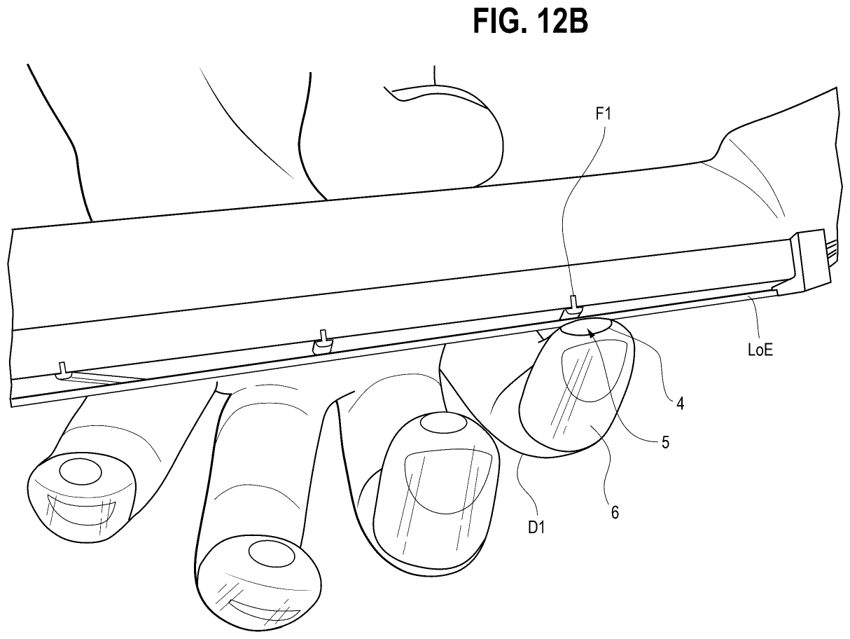

FIG. 12A shows a bare first finger (D1) fretting the low-E-string to fret 1 (Item F 1). Without the protection of the finger protector device 6, the soft flesh of the finger is compressed by counter force of the low-E-string pushing back on it. Additionally, the low-E-string causes fingertip creasing 160 as in FIG. 16. A bare fingered player suffers the discomfort of having his fingertips crushed note after note.

Continuing the example of FIG. 12A, the player must press the low-E-string to fret 1 with enough force to completely isolate his fingertip from string vibration. Otherwise, that soft fingertip will dampen the musical note.

In FIG. 12B, the same note is played as in FIG. 12A but with the finger protector device 6 on first finger D1. Protected by the stiff plastic of the finger protector device 6, the first finger keeps its normal shape. The counter force of the low-E-string against the circumferential-edge 4 is distributed widely over the entire finger pad. There is no discomfort. As the finger protector device 6 is preferably composed of hard plastic, it will not dampen notes and the player need only apply enough force to lightly trap the vibrating string between the finger protector device 6 and the fret. A player who wants to save wear on his fingers during practice can play softly with little effort. Playing with volume does require additional fretting finger force, however.

As the finger protector device 6 is hard plastic, it will never dampen string vibration. The result is great tone in normal string fretting and spectacular clarity and volume for hammer-ons and pull-offs.

Advantageous features of the finger protector device 6 are the combination of hard plastic and custom fit. Getting the fit correct is important. Each finger protector device 6 is purposely reduced in size to be slightly smaller than the intended finger. This helps it stay in place.

If the finger protector device is too small, the fingertip may retract inside. The fingertip should peek through the touch-hole 5 as in FIGS. 1B and 12B. If not, the finger protector device should be resized.

Carrying forward with the example of FIG. 12B, it is best if the tip of the finger through the touch-hole 5 makes initial contact with the low-E-string. That string indents the flesh of the fingertip slightly but much less than with the bare finger; the hard circumferential-edge 4 of the touch-hole 5 prevents it. Still, that minimum indentation of the fingertip provides tactile feedback and prevents the string from slipping away as full fretting force is applied by the circumferential-edge 4.

That minimum indentation of the fingertip relative to bare-fingered play makes fingers wearing the finger protector device 6 effectively longer.

The fingertip covered by the finger protector device 6 is the shape of a dome. If that hard plastic dome is the first point of contact with a string, in this example the low-E-string, that string tends to slip aside under fretting pressure and the note is muffed. This is why it is important that the bare tip of the finger peek through touch-hole 5.

Accuracy of string attack is paramount and more important than with bare-fingered play. If the plastic of the finger protector device is making initial contact, determine if the fingertip can touch the desired string (low-E-string in this continuing example) with a more accurate approach, perhaps a more perpendicular approach by moving the whole hand. If the plastic of the finger protector device 6 still makes initial string contact, it should be modified.

The touch-hole 1 can have an approximate diameter of 0.30 inches. However, each individual player will need to determine the diameter of touch-hole 5 for themself. Important as it is to prevent the severe fingertip creasing 160 of FIG. 16 some slight creasing is necessary to prevent a string from slipping aside.

In some playing situations, it is impossible for the flesh of the fingertip to make initial contact with a string. To understand the example presented here, it is necessary to know that the strings are numbered sequentially with the high-E-string (FIG. 10A: HiE) being number 1 and the low-E-string (FIG. 10A: LoE) being number 6. The third fret at the fourth string is an F note in the third octave. The sixth fret on the second string is an F note in the fourth octave. The specific frets here are just examples as this combination can be moved up and down the guitar neck GN (FIG. 10B). Simultaneously plucking these octave F notes creates an effective sound and is often played. Imagine the third and fourth fingers holding down the F on the second string. Even with a normal sized hand, there is no way to get the fingertip of the first finger to the F on the fourth string. With a little practice, however, a player can use the side of the finger protector device 6 toward the first fingertip to trap that F on the fourth string against the third fret and play the octave notes. The first choice is always to have the fingertips make initial string contact through the touch-hole 5, but when that is not possible, the player may still succeed with practice.

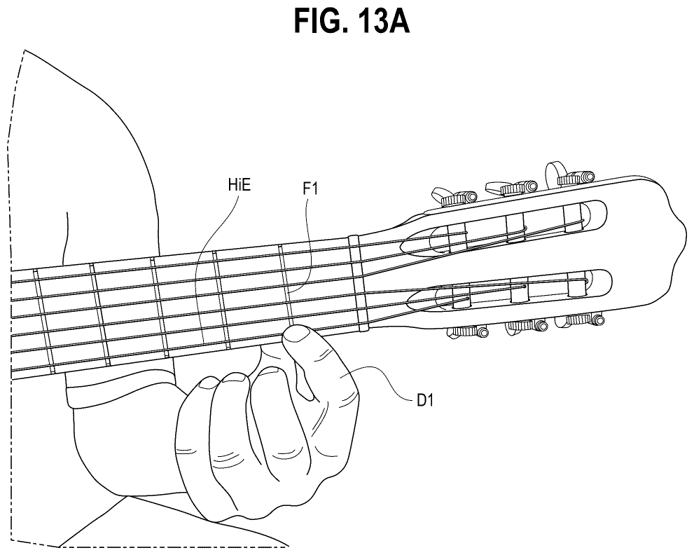

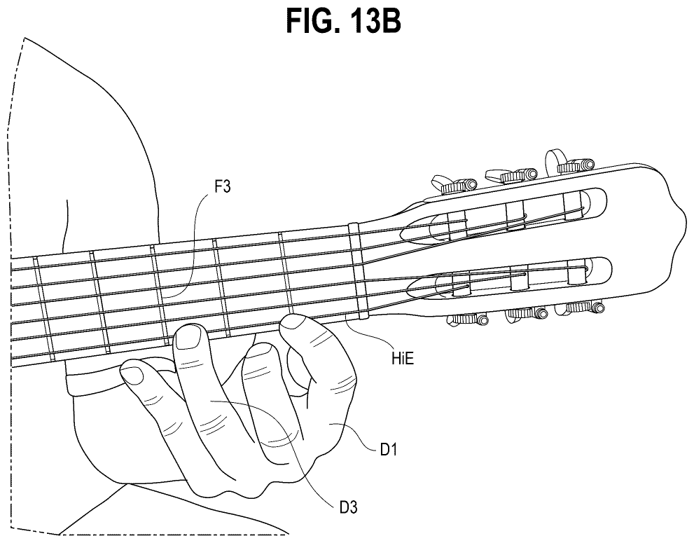

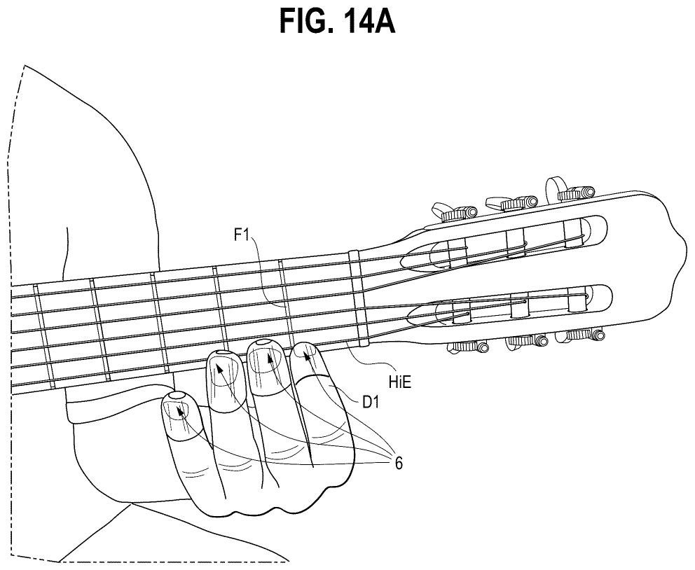

Observe the notes fretted in FIGS. 10C and 13A. Notice the acute angle with which the bare first finger D1 attacks the high-E-string. In either drawing, if the first finger were wearing the finger protector device 6, its hard plastic would make initial contact; the string would slip aside and the note would not sound. For the finger protector device 6 to expose enough fingertip to allow such acute angles of attack, the touch-hole 5 would be so large as to lose utility.

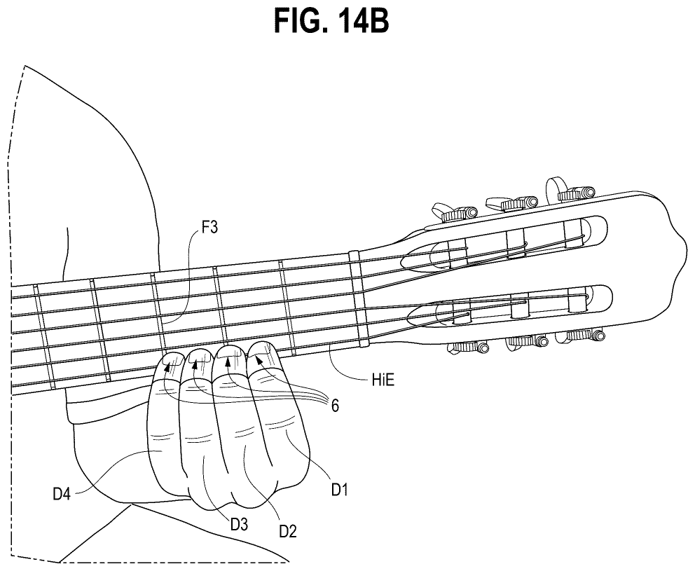

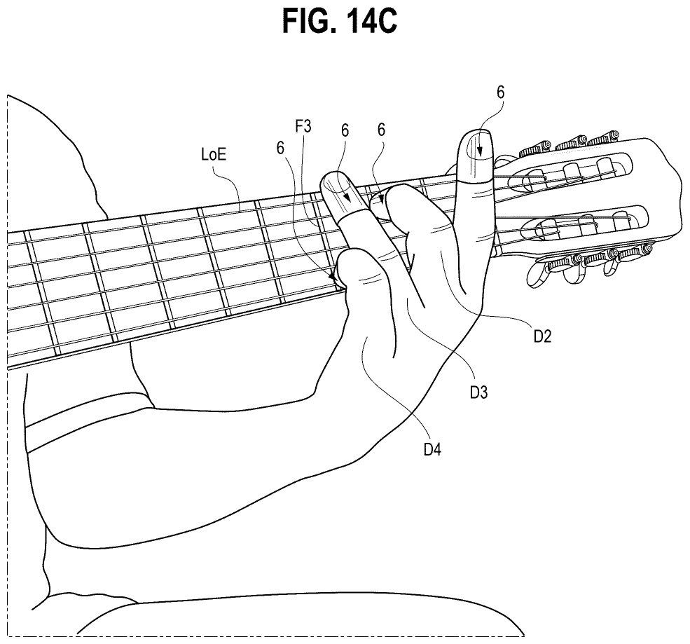

A modified string attack which plays the same note as FIGS. 10C and 13A is seen in FIG. 14A. Notice that the first finger D1 is wearing the finger protector device 6 and attacks square to the string. The note sounds with little effort.

Even after learning to attack notes square to the string, a player will need to experiment with both the size and shape of the touch-hole 5 to achieve a compromise between flexible attack angle and finger protection.

A technique to keep fingers square to the strings as in FIG. 14A is closely related to the musical embellishment known as “slides”. Slides involve hand movement along the guitar neck GN (FIG. 10B). To convey direction along the guitar neck, adopt the common phrase “up the neck”.

Slides are musical note transitions which may move up or down in pitch and may include any number of notes. Concentrate here on a simple half-step up in pitch. That occurs when a player maintains fretting pressure on a ringing string and slides over the current fret to the next fret “up the neck”. The player can feel where to stop because his finger feels resistance as it approaches that next higher fret.

Slides are particularly easy with the finger protector device 6. The bare fingertip peeking through the touch-hole 5 touches a string lightly providing tactile feedback without dampening the note. The real fretting force comes from the circumferential-edge 4 (FIG. 1A or 12B). The frictional resistance to movement along the string is not noticeable because of the small contact area and the smooth hard surface of the finger protector device 6. As hard plastic does not dampen string vibration, no volume is lost and the embellished slide note has a rich harmonic tone.

To see how slide technique with the finger protector device 6 applies to playing notes in sequence, consider FIGS. 14A and 14B. In FIG. 14A the same note is fretted as in the bare-fingered examples of FIGS. 10C and 13A. However, in FIG. 14A, the first finger D1 is wearing the finger protector device and approaches the string squarely to allow the fingertip to make initial string contact through touch-hole 5.

The next note in this two-note sequence seen in FIG. 14B at fret F3. With all four fingers gliding along the string, the whole hand moves up the neck. As if the pinky were concluding a slide, it feels resistance at fret 3 and stops. All fingers remain square to the strings as they must for direct fingertip contact when wearing the finger protector device 6. However, that square contact has required a short shift up the neck by the whole hand similar to a slide. To confirm that the hand has shifted in transition from FIG. 14A to FIG. 14B compare the position of the First Finger D1 in FIGS. 14A and 14B.

For use in the remainder of this document the term “micro-shift” is used to identify a shift in hand position as described above which is needed to keep fretting fingers square to the strings as notes progress through a musical piece. The shift is less than a fret in distance. In some cases, the left hand may hold a chord formation and micro-shift.

The two-sequenced notes just illustrated in FIGS. 14A and 14B are but one example of the many situations in which a player with the finger protector device 6 will need to micro-shift to keep fingers square to strings. These micro-shifts are extra movements to learn in playing guitar with the finger protector device. Once mastered, they do not affect musical timing.

All coordinated use of the hands and fingers requires muscle memory and tactile feedback. Guitar playing is no exception and thus the need for fingertips to maintain direct contact with strings through the touch-hole 5. String vibration is terminated by a hard contact point at the circumferential-edge 4.

For completeness, FIGS. 13A and 13B show how a bare-fingered player would play the same two-note sequence described above. The differences seen here are that the first and third fingers (D1 and D3) approach high-E-string at acute angles and the hand as a whole does not move along the guitar neck GN.

The two-note sequence discussed above in FIG. 13A and FIG. 13B includes the last two notes of a first position ascending scale in the key of C. The scale begins on the low-E-string. As a bare-fingered player progresses through the middle strings and finally to the high-E-string, he would not need to shift his hand up or down the neck. Nearly all bare-fingered women players and many male bare-fingered players could not play every note exactly at the fret. As you see in FIG. 13B, the third finger D3 falls short of fret 3 (F3).

The player wearing the finger protector device 6 would need to Micro-shift on nearly all the middle strings but he would play each note exactly at its fret. Playing each note exactly at its fret is an energy savings for the fingers. The sequence of FIG. 14A and FIG. 14B shows the final two notes of this ascending scale in the key of C as played with the finger protector device 6. In FIG. 14B the left hand has shifted so that the Pinky D4 rests on the High-E-string exactly at fret3 (F3).

Players wearing the finger protector device 6 should practice the well-known caged form-scales with eyes closed. Just the C, A, and G forms in the key of C will take the player up to the fifth position and are enough to get the feel of the micro-shift technique. The player should feel (but not see) each note at its fret.

The use of the finger protector device 6 in the preceding paragraphs made repeated mention of the importance of the finger-to-string-attack beginning with the fingertip making first string contact to be followed by circumferential-edge 4. Exceptions do occur. One such is seen in FIG. 14C. FIG. 14C is the common G Major chord where the third finger D3 wearing the finger protector device 6 touches only hard plastic of the low-E-String. The third finger has no bare fingertip contact to the low-E-string. It is important to note that the hand as a whole has stability from the second finger D2 and the pinky D4 attacking their strings squarely.

Configurations such as seen in FIG. 14C open the possibility for alternate embodiments as 6a in FIGS. 2A and 6b in FIG. 2B where the grit-patch 21 or the grip-hole 23 stabilizes fret action in the absence of fingertip contact.

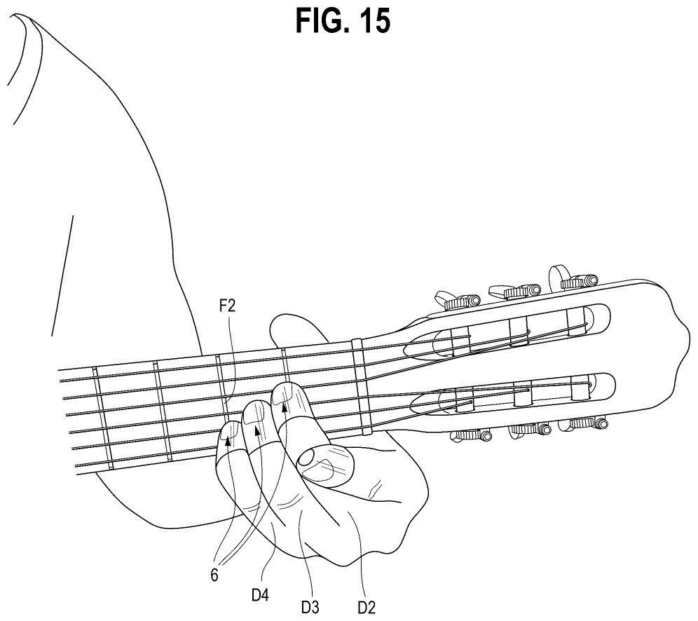

Fingers wearing the finger protector device 6 cannot squeeze as closely together as can bare fingers. An example is shown in the attempted A major chord in FIG. 15 where the finger protector device 6 prevents the second, third, and pinky fingers (Items D2, D3, D4) from squeezing together. As a result, the second finger D2 is so far from fret 2 (F2) that its note may not sound. Depending upon the order in which the notes of the A major chord appear in the music, the player may be able to hold the chord formation while micro-shifting and strumming simultaneously to catch that troublesome E note third octave under the second finger. Otherwise, some alternate chord must be found.

Finger crowding is a more restrictive issue on instruments with narrow necks and short scales such as the tightly space strings of steel string acoustic guitars and violins. This finger crowding issue is the reason that the finger protector device 6 is initially recommended only for the classical guitar with its F0-width (F0) of 2 inches (or 1⅞ inches) and its long 650 mm scale.

The finger protector device 6 incorporates the cut-out 1 feature which provides some additional clearance between fingers to ameliorate finger crowding. In FIG. 1B, the second finger (D2) has a lead line indicating a cut-out 1 on the thumb-side 3. The thumb-side of the third finger (D3) and pinky (D4) are also visible in the viewing angle of FIG. 1B and cut-outs 1 are seen on those fingers also but without item identification to avoid a clutter of numbers and lead lines. The first finger embodiment has no thumb-side neighbor and needs no cut-out 1.

Alternate embodiment 6c of FIG. 2C ameliorates the finger crowding issue by being shorter which leaves more shaft of the fingers exposed and thus able to compress.

From the foregoing, it will be observed that numerous variations and modifications may be effectuated without departing from the spirit and scope of the invention. It is to be understood that no limitation with respect to the specific apparatus illustrated herein is intended or should be inferred.

The invention claimed is:

1. A finger-protector device for guitar playing, comprising:
a shell formed as a tube with an open base end and a substantially closed distal end, and sized and shaped to fit tightly over a distal portion of a finger, the shell having a touch-hole on the distal end that is shaped to allow a guitar player to touch a selected guitar string with the finger.

2. The finger-protector device according to claim 1, wherein the shell is substantially stiff.

3. The finger-protector device according to claim 2, wherein the shell is composed of PETG plastic.

4. The finger protector device according to claim 1, comprising a circumferential edge surrounding the touch-hole.

5. The finger-protector according to claim 1, wherein the open base end comprises a substantially circular perimeter with an open area in the form of a cut-out extending from the substantially circular perimeter toward the distal end of the shell.

6. The finger-protector according to claim 1, wherein the maximum cross-section occupies a central portion of length.

7. The finger-protector according to claim 1 wherein the base end has reduced cross-section compared to a central portion.

8. A method of making a finger-protector device for guitar playing comprising the steps of:
making a physical model of a finger by use of an impression mold;
using the impression mold to cast a physical model;
3D scanning the physical model to make a 3D computer model of the physical model of the finger;
use 3D printing to make a thermoform template from the 3D computer model.

9. The method according to claim 8, wherein the step of making a 3D computer model comprises the further steps of applying CAD editing to smooth skin wrinkles and casting bubbles from the 3D computer model before 3D printing of thermoform template.

10. The method according to claim 8, wherein the step of making a 3D computer model comprises the further steps of applying CAD editing to shrink the 3D computer model to compensate for compressibility of the human finger to ensure a tight fit, before 3D printing of the thermoform template.

11. The method according to claim 8, wherein the step of making a 3D digital model comprises the further steps of applying CAD editing to install a touch-hole at a tip of the 3D scan and a cut-out at a side of the 3D computer model.

12. The method according to claim 8, comprising the further step of surrounding the proximal end of fingertip with elastic tape to reduce cross-section before taking impression mold.

13. The method according to claim 8, wherein the step of making a physical model of a finger by use of an impression-mold is further defined by using a dental technology timed-set impression material in the mold.

14. A method of making a finger-protector device for guitar playing comprising the steps of:
3D printing a thermoform template of a 3D computer model of a finger;
stretching a thin, hot plastic sheet over the template;
using vacuum thermoforming or positive pressure thermoforming, forming the plastic sheet into a shell.

15. The method according to claim 14, comprising the further steps of cutting out a touch-opening on a closed end of the shell and cutting out a side cut-out on a sidewall of the shell.
